(19) United States
(12) Patent Application Publication
(10) Pub. No.: US 2006/0228461 A1
(43) Pub. Date: Oct. 12, 2006

(54) Beta-glucan-containing products, methods of making same, and uses therefor

(76) Inventor: Keith Raymond Morgan, Petone (NZ)

Correspondence Address: FISH & RICHARDSON PC, P.O. BOX 1022, MINNEAPOLIS, MN, 55440-1022, US

(21) Appl. No.: 10/563,027

(22) PCT Filed: Jun. 30, 2004
(86) PCT No.: PCT/NZ04/00136

§ 371 Date: May 17, 2006

(30) Foreign Application Priority Data
Jul. 2, 2003 (NZ) 526829

(51) Int. Cl. A23L 1/00

(52) U.S. Cl. 426/618

(57) ABSTRACT

Novel beta-glucan-containing products formed from cereals are described as are methods for producing such products, and uses for such products. In one preferred aspect, the invention relates to flour-like cereal products containing beta-glucan.

### FIELD

The present invention relates to novel beta-glucan-containing products formed from cereals, methods for producing same, and uses thereof. More particularly the invention relates to flour-like cereal products containing beta-glucan.

### BACKGROUND

The term “beta-glucan” refers to those polysaccharides which comprise a linear polymer of D-glucopyranosyl units linked together by (1→3) and (1→4) beta-linkages.

beta-Glucans occur naturally in many cereal grains such as oats and barley. The molecular weight of beta-glucan molecules occurring in cereals is typically 200,000 to 2,000,000 Daltons.

beta-Glucan is desirable as a food additive, for example, to impart texture (“mouth feel”) to foods or useful as edible films for food coatings. beta-Glucan may also be used to add bulk to foods and has the advantage of having a neutral flavour. beta-Glucan may also add viscosity to foods.

beta-Glucan is also desirable as a therapeutic agent. There is evidence that beta-glucan can lower serum cholesterol levels, heal wounds, moderate glycaemic response, and alleviate constipation. beta-Glucan can actively bind to specific cell receptors and therefore may be useful for the treatment of a wide variety of disorders or diseases.

Therapeutic uses of beta-glucan, especially those related to the moderation of glycaemic response, appear to be related to the viscosity that it produces in the intestines. In turn the viscosity of solutions of beta-glucan are related to the molecular weight of the beta-glucan and the concentration of beta-glucan in solution. Thus it is advantageous, particularly for the moderation of glycaemic response, that the beta-glucan have a high molecular weight, for instance about 2,000,000 Daltons. It may also be considered advantageous for the concentration of beta-glucan in a solution to be greater than at least about 0.1% by weight.

However, if the molecular weight of the beta-glucan is lower than 2,000,000 Daltons then the concentration may need to be considerably higher than about 0.1% in order for the beta-glucan to have a significant therapeutic effect.

Cereals such as oats and barley typically contain between 2 and 4% beta-glucan. However, it is possible to obtain flours enriched in beta-glucan. These may be obtained by milling and wet or dry sieving, or by air classification of cereal flours, or by milling of special varieties of cereal grains that contain higher amounts of beta-glucan or combinations thereof. For instance with barley it is known that air classification can result in fractions containing up to 20% beta-glucan and that certain waxy varieties may contain more than 8% beta-glucan.

When a beta-glucan containing source material such as a cereal flour is mixed with water not all the beta-glucan in the flour may be released from the flour to dissolve in the water. The amount released depends on extraction conditions. For example, at extraction temperatures below 10 degrees C. less than 25% of the beta-glucan in the flour may be released after a 1 hour extraction process.

In extracting beta-glucan from a cereal flour the molecular weight of the beta-glucan decreases, due apparently to the hydrolysis of the beta-glucan by beta-glucan degrading enzymes associated with the cereal flour. This decreases the viscosity of the beta-glucan which appears to lower the therapeutic efficacy of the beta-glucan in, for example, moderating glycaemic response. It is therefore advantageous for certain applications to deactivate the enzyme prior to extraction. The known methods of deactivating these enzymes include heating the flour in mixtures of water and ethanol, or heating the flour with limited amounts of water so that starch gelatinisation is avoided. These methods result in a large increase in the molecular weight of the beta-glucan during extraction, however the amount of beta-glucan that is released under physiological conditions, that is at temperatures of about 37 degrees C. is greatly decreased. Generally if the enzymes are deactivated the quantity of beta-glucan that can be released at physiological temperatures may be as small as 30% of the total beta-glucan in the flour. Even if the enzymes are not deactivated only about 50% of the beta-glucan is released from the flour and the beta glucan will have a lower molecular weight under physiological conditions.

If most or all of the beta-glucan could be released from cereal flours under physiological conditions then the therapeutic efficacy of the flour, particularly in moderating glycaemic response, could be greatly increased.

### OBJECT

It is an object of the present invention to provide an improved beta-glucan containing processed cereal grain product, methods for obtaining same, or uses therefor or at least to provide the public with a useful choice of any one of the foregoing.

### SUMMARY OF INVENTION

In one aspect of the invention there is provided a beta-glucan-containing processed cereal grain product which when mixed with water at temperatures of between approximately 0 to 55 degrees C. releases at least approximately 60% of the beta-glucan into the water, the beta-glucan so released having an average molecular weight at least greater than approximately 100,000 Daltons and/or a specific viscosity greater than approximately 2.0 cSt at beta-glucan concentrations of approximately 0.5% by weight.

In a related aspect of the invention there is provided a beta-glucan-containing processed cereal grain product which when mixed with water in a weight to volume ratio of approximately 1 to 20 at temperatures of approximately 37 degrees C. for one hour releases at least approximately 60% of the beta-glucan into the water, the beta-glucan so released having an average molecular weight at least greater than approximately 100,000 Daltons.

In another aspect of the invention there is provided a beta-glucan-containing processed cereal grain product which when mixed with water in a weight to volume ratio of approximately 1 to 20 at temperatures of approximately 37 degrees C. for one hour releases at least approximately 60% of the beta-glucan into the water, the beta-glucan so released having a specific viscosity greater than approximately 2.0 cSt at beta-glucan concentrations of approximately 0.5% by weight.

Preferably, the product is a flour.

Preferably, the product is derived from cereal having a beta-glucan content greater than 6% by weight. More preferably, the product is derived from cereal having a beta-glucan content greater than 9% by weight.

Preferably the amount of beta-glucan released is greater than 75%.

Preferably the average molecular weight of the beta-glucan released is greater than approximately 500,000 Daltons and/or the specific viscosity at beta-glucan concentrations of approximately 0.5% is greater than approximately 20.0 cSt.

Preferably, the product contains additional components. Additionally, starch within the product is physically modified.

In a further aspect of the present invention there is provided a method for producing a beta-glucan-containing product comprising at least heating a beta-glucan-containing cereal grain above approximately 60 degrees C. in the presence of greater than approximately 50% water by weight of cereal grain followed by drying.

Preferably, the method comprises at least the steps of:
Mixing a beta-glucan-containing cereal grain with water to provide a mixture having greater than 50% by weight water;
Heating the mixture to above approximately 60 degrees C.; and
Drying the mixture.

Preferably, the mixing of the cereal grain with water occurs prior to heating. Alternatively, mixing of the cereal grain with water and heating occur simultaneously.

Preferably, the cereal grain contains greater than 6% beta-glucan. More preferably, the cereal grain contains greater than 9% beta-glucan.

Preferably the cereal grain is barley. Alternatively, the cereal grain is oats. In another aspect the cereal grain is a mixture of different cereal grains.

Preferably, the cereal grain is a processed cereal grain. More preferably, the processed cereal grain is a flour. More preferably, the flour is enriched for beta-glucan.

In a related aspect, the cereal grain and other food ingredients are mixed in combination with water in accordance with the invention so that the mixture has a water content above 50% by weight of the cereal grain.

Preferable the mixture is heated to a temperature greater than approximately 90 degrees C.

Preferably the mixture is milled to a flour following drying.

In another aspect, the invention provides a method as herein before described further comprising the step of adding one or more components or ingredients to the cereal grain and/or physically modifying and/or partially enzyme hydrolysing starch present in the cereal grain prior to, during, or after processing.

In a further aspect of the present invention there is provided a method for producing a beta-glucan-containing food product comprising at least the steps of:
Mixing a cereal grain in combination with other food ingredients with water to form a mixture having greater than 50% water by weight of cereal grain;
Heating the mixture to above approximately 60 degrees C.; and
Drying the mixture to form the product.

In another broad aspect, the invention provides a beta-glucan containing product produced by a method as herein before described.

In another broad aspect of the invention there is provided food products comprising at least a beta-glucan-containing product as herein before described. Preferably said food product is bread. Alternatively said food product is pasta. In another aspect, the food product is a processed food bar.

In a further broad aspect, the invention provides a pharmaceutical composition comprising at least a beta-glucan-containing product as herein before described.

In yet another broad aspect of the invention there is provided a process for making a food product comprising at least the step of preparing a beta-glucan-containing product of the invention.

In another aspect, the invention provides the use of a beta-glucan-containing product of the invention in the manufacture of a medicament for moderating glycaemic response and/or lowering serum cholesterol levels and/or alleviating constipation.

In yet a further aspect, the invention provides a method of moderating glycaemic response and/or lowering serum cholesterol levels, and/or alleviating constipation in a subject, the method comprising at least the step of administering a beta-glucan-containing product of the invention to the subject.

The invention may also be said broadly to consist in the parts, elements and features referred to or indicated in the specification of the application, individually or collectively, in any or all combinations of two or more of said parts, elements or features, and where specific integers are mentioned herein which have known equivalents in the art to which the invention relates, such known equivalents are deemed to be incorporated herein as if individually set forth.

Other aspects of the invention may become apparent from the detailed description and examples provided herein after.

### Preferred Embodiment(s)

The following is a description of the preferred forms of the present invention given in general terms. The invention will be further elucidated from the Examples provided herein after.

The inventor has surprisingly realised a novel beta-glucan-containing processed cereal grain product, which at temperatures between approximately 0 and 55 degrees C. may release more beta-glucan, having a higher molecular weight, when compared to alternative cereal-based products. Particularly, the beta-glucan-containing product is capable of releasing at least approximately 60% of the beta-glucan into the water, more preferably, at least approximately 65 to 70%, and even more preferably at least approximately 75% of the beta-glucan at physiological temperatures (ie approximately 37 degrees C.). The beta-glucan so released has an average molecular weight at least greater than approximately 100,000 Daltons, more preferably greater than 500,000 Daltons, and/or a specific viscosity greater than approximately 2.0 cSt, more preferably greater than approximately 20.0 cSt, at beta-glucan concentrations of approximately 0.5% by weight.

A particularly preferred embodiment of the invention is a beta-glucan-containing processed cereal grain product which releases at least approximately 60%, preferably at least approximately 65 to 70%, and more preferably at least approximately 75% of the beta-glucan into the water when mixed with water in a weight to volume ratio of approximately 1 to 20 at temperatures of approximately 37 degrees C. for one hour.

Persons of ordinary skill in the art to which the invention relates will readily appreciate methods for determining one or more of the level of beta-glucan released into water (as above mentioned), the molecular weight of beta-glucan, and the specific viscosity of the beta-glucan. However, particularly preferred methods of determining these features are provided herein after in the “Examples” section.

The product above described may be made, for example, by a method of the invention described herein after.

In addition to the above detailed product, the inventor has unexpectedly found that heating a cereal grain at approximately 95 degrees C., with greater than approximately 50% water by weight, followed by at least drying produces a material having not only beta-glucan of greatly increased molecular weight that is released under physiological conditions, but also which releases significantly increased amounts of beta-glucan. The inventor believes heating at temperatures of above approximately 60 degrees C. will allow for such results.

Using such conditions may have additional advantages. For example, cereals contain starch degrading enzymes. Barley in particular contains large quantities of beta-amylases (about 0.1% by weight) and to a lesser extent alpha-amylase. These enzymes can degrade starch which may be undesirable in certain processed food applications. Heating cereals grains in the presence of water above for example about 70° C. for about 60 min or above about 75° C. for 15 min will denature beta-amylase in barley. Thus the cereal grain so treated will have no starch degrading activity.

As used herein in relation to the release of beta-glucan from a product of the invention the term “physiological conditions” is intended to include conditions normally found in a particular subject, preferably a mammal, and includes temperatures of between approximately 36 to 38 degrees C., particularly 37 degrees C.

In one embodiment, the novel method comprises at least the steps of mixing a cereal grain with water to form a mixture having greater than approximately 50% water by weight, heating the mixture to above approximately 60 degrees C., and drying the mixture. In one embodiment, the cereal grain is mixed with water prior to heating. In an alternative embodiment the cereal grain is heated and mixed with water simultaneously.

In a preferred embodiment the method comprises mixing a cereal grain with water to form a mixture having greater than approximately 60% by weight water, more preferably greater than approximately 65% by weight water.

In another preferred embodiment, the method comprises at least the steps of mixing a cereal grain with greater than 50% by weight water to form a mixture, heating the mixture to above approximately 60 degrees C., and drying the mixture.

In a preferred embodiment the mixture is heated to above approximately 70 degrees C., or 80 degrees C. In a particularly preferred embodiment of the method of the invention, the cereal grain/water mixture is heated to a temperature greater than 90 degrees C., preferably approximately 95 degrees C.

In a preferred embodiment, the mixture is milled to a flour following drying.

As noted above, the method of the invention utilizes cereal grains to form a product of the invention. In a preferred embodiment, the beta-glucan content of the cereal grain is greater than approximately 6% by weight, more preferably greater than approximately 9% by weight. Examples of appropriate cereal grains include barley and oats.

The method of the invention most preferably uses processed cereal grain as the starting material. Such processed cereal grains include flours and grits obtained from the cereal grains by standard methods. Processed cereal grains also include beta-glucan enriched flours (ie flours that contain a higher proportion of beta-glucan relative to the proportion of beta-glucan in the grain from which the flour is derived), which may be manufactured according to techniques known in the art to which the invention relates; for example milling and air classification or milling and sieving. In one particularly preferred embodiment a flour enriched in beta-glucan so that it contains at least 1.5 times the amount of beta-glucan as in the source grain, and at least 40% of the beta-glucan present in the source grain, is used as starting material. References to the use of cereal grains in the context of the invention should be taken to include references to processed forms of these cereal grains. While it is preferable that the starting material is a processed cereal grain, the inventors contemplate a method of the invention being applicable to cereal grains substantially in their natural state.

Mixing of the cereal grain with water may occur by any means known to persons of ordinary skill in the art to which the invention relates.

It should be appreciated that following the initial mixing of the cereal grain with water the mixture may be held for a period of time prior to heating.

Heating of the mixture may occur via techniques standard in the art to which the invention relates. By way of example heating may occur in a stirred container.

The period of time the mixture is heated for may vary depending on such factors as the temperature used and the pressure conditions of the heating step. By way of general example temperature and/or pressure are inversely related to the period of heating. For example, as the temperature increases, the period of time may decrease. In a preferred embodiment of the invention, the mixture is heated to the desired temperature for a period of between from approximately one minute to one hour, more preferably from between approximately 15 minutes to 1 hour. However, the inventors contemplate the mixture being brought to a desired temperature and then substantially immediately entering the drying step.

Drying may be done using any standard methods readily known to skilled persons. For example, on a commercial scale drying may occur using a hot roller drier or by spray drying. Alternative means of drying are outlined herein after under the heading “Examples”.

It should be appreciated that “drying” as used herein, should not be taken to necessarily infer drying to the point where the mixture or final product has no water or moisture present. The final product may have a level of moisture present. Preferably, the product has a moisture content which is sufficiently low so that growth of microbiological organisms is arrested. For a product containing substantially only cereal components, the moisture content is preferably less than approximately 13%.

The optional milling of the mixture following the drying step can occur by any standard means which will be known to persons of ordinary skill in the art to which the invention relates. However, by way of general example, on a commercial scale the milling step may occur using a hammer miller.

A beta-glucan-containing product of the invention can be physically modified where desired. For instance the starch could be retrograded. Persons of ordinary skill in the art to which the invention relates will appreciate various standard methods for doing this including cooling and warming of the gelatinised starch and shearing the gelatinised starch. This may produce a product that is enzyme resistant. The starch may also be reacted with lipids during gelatinisation so that the amylose component of the starch is complexed with the lipids. The starch may also be partially hydrolysed with starch degrading enzymes. Such modification may occur prior to, during, or after processing to form the end product as per the invention.

Generally the beta-glucan-containing processed cereal grain products of the invention contain the same components after processing as they do before processing but the physical state of the components is different. For instance the starch may be partially or fully gelatinised. The beta-glucan contained in a product of the invention will generally be derived from the beta-glucan in the grain before processing; ie the native beta-glucan. However, it may be advantageous in certain situations to add additional components or ingredients to the grain during processing. By way of example, beta-glucan may be added to the grain to increase the beta-glucan content of the grain, or additional protein may be added. The product of the invention may then be defined by how much of the native beta-glucan is released at physiological temperatures.

Additional components or ingredients may be added to a product of the invention during processing. This may be done according to standard procedures in the art having regard to the result desired. Accordingly, the method of the invention may include further steps such as those that involve the addition of a further component as desired. The additional components may be added to the cereal grain prior to processing, during processing, or after processing in a method herein before described.

As mentioned hereinbefore, in one particularly preferred embodiment of the invention a cereal flour (preferably barley flour) that is enriched in beta-glucan so that it contains at least 1.5 times the amount of beta-glucan as in the source grain, and at least 40% of the beta-glucan present in the source grain, is used as starting material. Such a cereal flour may be produced by a method including: (i) milling a cereal grain so that from about 10 to about 90% of the flour particles are less than 200 μm in size; (ii) dry sieving the milled flour using a screen having a mesh size of approximately 100 to 350 μm and collecting a coarse fraction from the top screen and a fine fraction passing through the screen; (iii) dry sieving the fine fraction using a screen having a mesh size of approximately 50 to 150 μm, but less than the mesh size of the screen in step (ii), so that an enriched beta-glucan fraction is collected from the top screen and an enriched starch fraction is collected from the fraction that passes through the screen; (iv) optionally milling the coarse fraction for step (ii) and repeating steps (ii) through (iv) at least a number of times so that all fractions enriched in beta-glucan, that is all fractions except the enriched starch fractions described in step (iii), contain at least 1.5 times the amount of beta-glucan as the source grain and at least 40% of the beta-glucan in the source grain is present in the fractions enriched in beta-glucan fractions; (v) cooking the coarse fraction; and, (vi) drying the cooked fraction.

It should be appreciated that milling may occur using any appropriate means. For example, a roller mill or hammer mill may be used. Preferably the initial milling is done by a roller mill which uses a flat roller whereas subsequent rollers are preferably fluted. Further, different sieve sizes may be used. The process may be continuous where the barley grain is milled using a variety of mills and sieved over a series of one or more sieves to give a series of flour streams.

Preferably the grain is processed in a milling flour mill using more than one set of rollers for breaking, sizing and reducing the grain, combined with several sets of sieves optimised for yield and purity of the beta-glucan enriched fraction and the yield of the enriched starch fraction.

It is preferred that any bran in the flour be removed by a purifier. The bran may also be treated in a bran finisher to increase the yield and purity of the enriched beta-glucan flour and the yield of the depleted beta-glucan flour.

In a preferable embodiment of the above method, the source grain is first pearled to remove 10 to 20% of the outer layers of the grain.

Following processing in the above manner, the beta-glucan enriched flour may be used as the starting material in a process of the invention as claimed.

Preferably the enriched beta-glucan is mixed with other grains or ingredients prior to cooking, so that a dried produce is produced that contains less barley flour with enhanced levels of viscosity and release of more beta-glucan, than would be the case if the barley flour had not been enriched in beta-glucan.

The beta-glucan-containing product of the invention may be used as or in food products. By way of example the product may be used in any processed food produced at least in part from cereal grains. Particular examples include breads and pastas. Such products may be made, for example, by conventional means simply using the beta-glucan-containing product of the invention as an ingredient. An example of a method for preparation of a bread is provided herein after under the heading “Example 4”.

The beta-glucan containing product may also be used in the likes of a processed food bar (for example cereal, protein or health bars) or dried breakfast cereal. Such products would be useful as healthy snacks which have a low glycaemic index.

While a food product may be made by convention means as mentioned above, the inventors contemplate producing such products using the process of the present invention—ie the desired beta glucan can be formed simultaneously with production of the product. For example the starting material may be combined with one or more other cereals and/or other ingredients during a heating and gelatinisation step in, the presence of water (to greater than approximately 50% water by weight of cereal and then dried.

Beta-glucans are known to have certain therapeutic properties. In particular they find use in moderating glycaemic response in mammals as herein before described. They are also useful in alleviating constipation and lowering serum cholesterol. Accordingly, the beta-glucan-containing product of the invention may be used pharmaceutically, alone or in combination with suitable active ingredients and/or pharmaceutically acceptable diluents, carriers and/or excipients to form pharmaceutical compositions. Suitable active ingredients and/or pharmaceutically acceptable diluents, carriers and/or excipients will be readily appreciated by persons of ordinary skill in the art to which the invention relates. Generally they will be substances that are useful in preparing a pharmaceutical composition, may be co-administered with a beta-glucan-containing product of the invention while allowing it to perform its intended function, and are generally safe, non-toxic and neither biologically nor otherwise undesirable. Pharmaceutically acceptable diluents, carriers and/or excipients include those suitable for veterinary use as well as human pharmaceutical use. Examples of pharmaceutically acceptable diluents, carriers and/or excipients include solutions, solvents; dispersion media, delay agents, emulsions and the like.

Having the beta-glucan-containing product of the invention to hand, appropriate pharmaceuticals may be formulated into standard dosage forms (for example capsules and tablets), by combining with various actives and/or excipients, carriers or diluents, in accordance with standard methodology.

On the basis of the biological function of the beta-glucans a further embodiment of the invention encompasses the use of a beta-glucan-containing product of the invention, or foodstuffs and/or pharmaceutical compositions containing same in methods of moderating glycaemic response and/or alleviating constipation and/or lowering serum cholesterol levels in a subject. Such methods may simply involve the administration of an effective amount of a beta-glucan product of the invention to a subject in need thereof.

It will be appreciate that a “subject” as used herein is intended to include any animal, preferably a mammal, and more preferably a human.

As used herein administration of an “effective amount” of a beta-glucan product of the invention is an amount necessary to at least partly attain a desired response.

It will be appreciated that the amount of a beta-glucan-containing product (or food or pharmaceutical composition comprising same) administered to a subject, the period of administration, and the general administration regime may differ between subjects depending on such variables as the severity of symptoms of a subject, the type of disorder to be treated, the mode of administration chosen, and the age and/or general health of a subject.

### EXAMPLES

In the following examples the % beta-glucan extracted into solution was determined by taking a sample of the extract and measuring the beta-glucan content of the sample using a method based on the McCleary method (AACC Method 32-23) for determining beta-glucan content. The total beta-glucan released was then calculated assuming that the same concentration of beta-glucan that was in the sample was in all the water added during extraction. Viscosity was measured with a Cannon-Manning viscometer.

The approximate weight average molecular weight, Mw, was determined using a theoretical model relating Mw to beta-glucan viscosity and concentration. The model was based on Mw's derived from multiangle laser light scattering (MALLS) for beta-glucans standards having Mw ranging from 10,000 to about 400,000 Daltons. The viscosity of these standards was measured at concentrations ranging from 0.1 to 1.0%. Parameters for the model were determined from the Huggins equation and the Mark-Houwink relationship as explained by N. Bohm and W.-M. Kulicke (Carbohydr. Res. 315, (1999), 293-301). As will be appreciated by skilled persons, determinations of Mw by this method are only approximate. Results may differ from the true Mw by amounts up to about 30%.

### Example 1

### Comparative Example

A flour enriched in beta-glucan (11% beta-glucan on a dry weight basis) was brought to a moisture content of 23% by adding additional water and mixing well with the flour. The flour was then heat treated at 95 degrees C. for 1 h to deactivate beta-glucan degrading enzymes in the flour and then dried in a vacuum desiccator. The dried flour (200 mg) was extracted into water (2 ml) at 37 degrees C. for 1 h. The extract was centrifuged and the supernatant collected. The specific viscosity, asp, of the supernatant was found to be 255 cSt. When the supernatant was diluted by an addition of an equal volume of water the specific viscosity was found to be 7.73. These viscosities correspond to Mw of approximately 1,400,000 Daltons. The amount of beta-glucan released was found to be 31%.

In contrast for the same flour that was not heat treated but extracted under identical conditions the viscosity was found to be 17.5 cSt, which corresponds to a viscosity of about 450,000 Daltons and the amount of beta-glucan released was about 51%.

### Example 2

A flour enriched in beta-glucan (1 g, 11% beta-glucan on a dry weight basis) with a moisture content of 13% was gelatinised with water (1.5 ml) (to provide a mixture having approximately 65% by weight water/moisture) at 95 degrees C. for 15 min, dried as a thin film on a stainless steel plate at 140 degrees C. and then ground to a flour-like powder. The flour-like powder (200 mg) was extracted into water (4 ml) at 37 degrees C. for 1 h. The extract was centrifuged and the supernatant collected. The amount of beta-glucan released was found to be 79%. The specific viscosity of the supernatant was found to be 30.8 cSt, which corresponds to Mw of about 2,000,000 Daltons. Comparing this with the previous example the specific viscosity is about 4 times greater than that for the heat treated flour (ηₛₚ=7.73) which had a much greater viscosity than the untreated flour. beta-Glucan release was much greater 50% compared to the previous example where for the heat-treated flour the beta-glucan release was only 31% and for the untreated flour it was 51%.

### Example 3

### Comparative Example

A flour enriched in beta-glucan (500 mg, 11% beta-glucan on a dry weight basis) with a moisture content of 13% was mixed water (100 mg) to give a total moisture content of about 30% and the mixture was heated at 125 degrees C. for 15 min in a small bomb. The product was removed from the bomb and dried as a thin film on a stainless steel plate at 140 degrees C. and then ground to a powder. To the powder (100 mg) was added water (4 ml) and the beta-glucan was extracted at the temperature of the human body (37 degrees C.) for 1 h. It was found that about 54% of the total beta-glucan in the flour was extracted into the aqueous phase. This is considerably less than for the flour treated according to Example 2.

### Example 4

A simulation of bread baking was undertaken which replaced 20% of the wheat flour with the product treated according to Example 2 and a control of the untreated beta-glucan enriched barley flour. Therefore a flour enriched in beta-glucan (200 mg, 11% beta-glucan on a dry weight basis) with a moisture content of 13% was gelatinised with water (300 μl) on a boiling water bath for 15 min. The product was then dried as a thin film on a stainless steel plate at 140 degrees C. The dried product was then ground in a mortar and pestle. The dried product and a control sample of the original flour (100 mg) were each separately mixed with 400 mg of wheat flour. Water (350 μl) was added to each mixture and the mixtures were stirred to form doughs. The doughs were left at 30 degrees C. for 2 h and then “baked” by heating at 95 degrees C. for 20 min. The beta-glucan in the baked products were extracted into water (4 ml) at 37 degrees C. for 1 h. The extracts were centrifuged and the supernatants collected. The viscosity and the beta-glucan content of the supernatants were determined. For the treated barley flour the specific viscosity was found to be 28.34 and the beta-glucan content of the solution was 0.31 weight %. In contrast for the control barley flour the viscosity was only 5.73 and the beta-glucan content of the solution was 0.21 weight %. Thus about 50% more beta-glucan was released in the bread made from the treated barley flour than in the control flour and the viscosity of the beta-glucan extracted from the treated flour was very much higher.

The invention has been described herein with reference to certain preferred embodiments, in order to enable the reader to practice the invention without undue experimentation. Those skilled in the art will appreciate that the invention is susceptible to variations and modifications other than those specifically described. It is to be understood that the invention includes all such variations and modifications. Furthermore, titles, headings, or the like are provided to enhance the reader's comprehension of this document, and should not be read as limiting the scope of the present invention.

The entire disclosures of all applications, patents and publications, cited above and below, if any, are hereby incorporated by reference.

The reference to any prior art in this specification is not, and should not be taken as, an acknowledgment or any form of suggestion that that prior art forms part of the common general knowledge in New Zealand or any other country.

Throughout this specification, and any claims which follow, unless the context requires otherwise, the words “comprise”, “comprising” and the like, are to be construed in an inclusive sense as opposed to an exclusive sense, that is to say, in the sense of “including, but not limited to”.

1. A beta-glucan-containing processed cereal grain product which when mixed‘with water at temperatures of between approximately 0 to 55 degrees C. releases at least approximately 60% of the beta-glucan into the water, the beta-glucan so released having an average molecular weight at least greater than approximately 100,000 Daltons and/or a specific viscosity greater than approximately 2.0 cSt at beta-glucan concentrations of approximately 0.5% by weight.

2. A beta-glucan-containing processed cereal grain product which when mixed with water in a weight to volume ratio of approximately 1 to 20 at temperatures of approximately 37 degrees C. for one hour releases at least approximately 60% of the beta-glucan into the water, the beta-glucan so-released-having an average molecular weight at least greater than approximately 100,000 Daltons.

3. A beta-glucan-containing processed cereal grain product which when mixed with water in a weight to volume ratio of approximately 1 to 20 at temperatures of approximately 37 degrees C. for one hour releases at least approximately 60% of the beta-glucan into the water, the beta-glucan so released having a specific viscosity greater than approximately 2.0 cSt at beta-glucan concentrations of approximately 0.5% by weight.

4. A beta-glucan-containing processed cereal grain product as claimed in claim 1 wherein the product is a flour.

5. A beta-glucan-containing processed cereal grain product as claimed in claim 1 wherein the product is derived from cereal having a beta-glucan content greater than 6% by weight.

6. A beta-glucan-containing processed cereal grain product as claimed in claim 5 wherein the product is derived from cereal having a beta-glucan content greater than 9% by weight.

7. A beta-glucan-containing processed cereal grain product as claimed in claim 1 wherein the amount of beta-glucan released is greater than 75%.

8. A beta-glucan-containing processed cereal grain product as claimed in claim 1 wherein the average molecular weight of the beta-glucan released is greater than approximately 500,000 Daltons and/or the specific viscosity at beta-glucan concentrations of approximately 0.5% is greater than approximately 20.0 cSt.

9. A beta-glucan-containing processed cereal grain product as claimed in claim 1 wherein the product contains additional components.

10. A beta-glucan-containing processed cereal grain product as claimed in claim 1 wherein starch within the product is physically modified.

11. A method for producing a beta-glucan-containing product comprising at least heating beta-glucan-containing cereal grain above approximately 60 degrees C. in the presence of greater than approximately 50% water by weight followed by drying.

12. A method as claimed in claim 11 wherein the method comprises at least the steps of:
mixing a beta-glucan-containing cereal grain with water to provide a mixture having greater than 50% by weight water;
heating the mixture to above approximately 60 degrees C.; and
drying the mixture.

13. A method as claimed in claim 12 wherein the mixing of the cereal grain with water occurs prior to heating.

14. A method as claimed in claim 12 wherein the mixing of the cereal grain with water and heating occur simultaneously.

15. A method as claimed in any claim 11 wherein the cereal grain contains greater than 6% beta-glucan.

16. A method as claimed in claim 15 wherein the cereal grain contains greater than 9% beta-glucan.

17. A method as claimed in claim 11 wherein the cereal grain is chosen from one or more of barley and/or oats.

18. A method as claimed in claim 11 wherein the cereal grain is a mixture of different cereal grains.

19. A method as claimed in claim 11 wherein the cereal grain is a processed cereal grain.

20. A method as claimed in claim 19 wherein the processed cereal grain is a flour.

21. A method as claimed in claim 20 wherein the flour is enriched for beta-glucan.

22. A method as claimed in claim 11 wherein the mixture is heated to a temperature greater than approximately 90 degrees C.

23. A method as claimed in claim 11 wherein the mixture is milled to a flour following drying.

24. A method as claimed in claim 11 wherein the method further comprises the step of adding one or more components or ingredients to the cereal grain and/or physically modifying and/or partially enzyme hydrolysing starch present in the cereal grain prior to, during, or after processing.

25. A beta-glucan-containing product produced by a method of claim 11.

26. A food product comprising at least a beta-glucan-containing product as claimed in claim 1.

27. A food product as claimed in claim 26 wherein the food product is bread, pasta or processed food bar.

28-29. (canceled)

30. A pharmaceutical composition comprising at least a beta-glucan-containing product as claimed in claim 1.

31-32. (canceled)

33. A method of moderating glycaemic response and/or lowering serum cholesterol levels,and/or alleviating constipation in a subject, the method comprising at least the step of administering to a subject a beta-glucan-containing product as claimed in claim 1.

34. A method for producing a cereal flour that is enriched in beta-glucan, the method comprising at least the steps of:
(i) milling a cereal grain so that from substantially 10% to substantially 90% of the flour particles are less than substantially 200 μm in size;
(ii) dry sieving the milled flour using a screen having a mesh size of substantially 100 μm to substantially 350 μm and collecting a coarse fraction from the top screen and a fine fraction passing through the screen;
(iii) dry sieving the fine fraction using a screen having a mesh size of substantially 50 μm to substantially 150 μm, but less than the mesh size of the screen in step (ii), so that an enriched beta-glucan fraction is collected from the top screen and an enriched starch fraction is collected from the fraction that passes through the screen; and
(iv) optionally milling the coarse fraction for step (ii) and repeating steps (ii) through (iv) at least a number of times so that all fractions enriched in beta-glucan contain at least substantially 1.5 times the amount of beta-glucan as the source grain and at least substantially 40% of the beta-glucan in the source grain is present in the fractions enriched in beta-glucan fractions.
